(19) United States
(12) Patent Application Publication
(10) Pub. No.: US 2025/0199761 A1
(43) Pub. Date: Jun. 19, 2025

(54) PRODUCT REDUCTION TREE FOR MACHINE REPRESENTATION

(71) Applicant: Orange, Issy-les-Moulineaux (FR)

(72) Inventors: Guillaume LARUE, CHATILLON CEDEX (FR); Louis Adrien DUFRENE, CHATILLON CEDEX (FR); Quentin LAMPIN, CHATILLON CEDEX (FR)

(21) Appl. No.: 18/986,556

(22) Filed: Dec. 18, 2024

(30) Foreign Application Priority Data
Dec. 19, 2023 (FR) FR2314464

(51) Int. Cl. G06F 7/487

(52) U.S. Cl. CPC G06F 7/4876

(57) ABSTRACT

A computing means which aggregates initial distributions into an aggregated distribution, the initial distributions being associated with vectors of real values representable in a predefined representation format in which the values representable in this format are between a minimum representable value and a maximum representable value, where, for the aggregation of the initial distributions, the computing means is configured to implement, iteratively: a grouping of distributions to form a plurality of distribution subsets, and product operations, term by term, on the distribution subsets, the products resulting in at least one intermediate distribution, followed by a normalization operation on each intermediate distribution, until the aggregated distribution is obtained, where each grouping of distributions is implemented such that the product operations on the distribution subsets lead to resulting values that are strictly greater than the minimum representable value.

### CROSS-REFERENCE TO RELATED APPLICATIONS

This application claims foreign priority to FR2314464, filed Dec. 19, 2023. The contents of the priority application are incorporated by reference herein in its entirety.

### BACKGROUND

### Field

This disclosure relates to the field of computer programming in the context of calculating the products of floating point numbers via a machine. In particular, this disclosure has applications in the field of digital technology or in telecommunications, for the reconstruction of signals and/or data from a plurality of distributions.

### Description of the Related Technology

In many digital and industrial applications, reconstructing information requires aggregating a plurality of data from multiple sources, expressed in different forms and/or containing correlations or redundancies. Typically, such a plurality of data can be expressed in the form of probability distributions reflecting several observations or occurrences related to the same parameter or variable, more generally the same information. Aggregating these different probability distributions then allows reconstructing the information in an aggregated form.

For example, in the field of telecommunications, demodulation methods for a cyclic code shift keying (or CCSK) system, in particular what is referred to as a CCSK-CP-OFDM system, may be based on relative probability distributions reflecting differences between the different symbols of a frame. For a pair of considered symbols, such distributions are then similar to a plurality of estimates of a relative distribution of one symbol with respect to the other. Aggregating these different estimates then makes it possible to estimate such a single relative distribution.

In another example, in the field of error correction codes, the aggregation of redundant information may also take place during a decoding phase. For example, a repetition code consists of transmitting different messages which repeat each transmitted bit of information several times in order to account for possible transmission errors. Estimating the value of a bit of information may then involve aggregating the probability distributions associated with the different repetitions of this bit, transmitted in the different messages.

In order to reconstruct information from a plurality of distributions, it is common to aggregate the different distributions in the form of a term-by-term product calculation over the different distributions. Such a product is then normalized in order to return the information to the form of a single aggregate distribution. For example, the plurality of probability distributions describing a same variable may be aggregated in the form of a product of probabilities, then normalized so as to obtain a single distribution of probabilities in which the sum of the terms remains equal to one.

However, in many cases, the product of such a plurality of distributions leads to multiplying increasingly smaller floating-point numbers: typically, successive term-by-term products of probabilities between 0 and 1 can quickly reach values on the order of 10⁻¹⁰, 10⁻²⁰, 10⁻³⁰ or less. Such a product then poses problems in machine representation of the numbers.

Indeed, floating-point numbers (or “floats”) can be represented in machines according to several standardized formats. For example, the IEEE 754 standard (defined by the Institute of Electrical and Electronics Engineers) defines several formats for representing a floating-point number, including the 32-bit format (“single precision”). In such a 32-bit format, any representable floating-point number can be encoded by 1 sign bit, 8 exponent bits, and 23 significand bits. Such encoding therefore allows representing absolute values between approximately 1.17×10⁻³⁸ and 3.4×10⁺³⁸.

However, it often happens that the results of successive products of small values are below the minimum representable value (e.g., 1.17×10⁻³⁸ for the single precision format). This results in a phenomenon called “arithmetic underflow”, defined as an inability to represent a number in machine representation, the number being considered to be closer to zero than any other number representable in this format. In such case, the result is rounded to zero. The information resulting from such a product (for example in a decoder receiving transmissions and reconstructing the corresponding signal) then becomes erroneous or altered.

### SUMMARY

This disclosure improves the situation.

A computing means is provided, configured to aggregate a plurality of initial distributions into an aggregated distribution, said initial distributions being associated with vectors of values, each value being a real floating-point number and being representable by the computing means according to a predefined representation format in which the values representable in this format are between a minimum representable value and a maximum representable value, wherein, for the aggregation of the initial distributions, the computing means is configured to implement, iteratively: a grouping of distributions to form a plurality of distribution subsets, and product operations, term by term, on the distribution subsets, said products resulting in at least one intermediate distribution, followed by a normalization operation on each intermediate distribution, until the aggregated distribution is obtained, wherein each grouping of distributions is implemented such that the product operations on the distribution subsets lead to resulting values that are strictly greater than the minimum representable value.

As a result, the proposed computing means advantageously makes it possible to aggregate diverse observable data taking the form of a plurality of initial distributions, into aggregated information. Such aggregation is particularly relevant when the initial distributions reflect different occurrences or functions describing the same variable, the same parameter, or the same information. In particular, the proposed computing means allows, regardless of the representation format used, implementation by machine and representation of the data from such an aggregation, which may involve a large amount of data to be aggregated, in particular when several thousand initial distributions are aggregated and/or when the initial distributions comprise several hundred or several thousand values for example.

The proposed computing means is particularly advantageous when the aggregation of initial distributions involves term-by-term product operations over the plurality of initial distributions. Indeed, when a large number of values are aggregated by product operations and in particular depending on the order of magnitude of such values, an arithmetic underflow phenomenon may occur, linked to problems with machine representation of a float. Typically, when successive product operations are carried out on values between 0 and 1, the resulting values can be on the order of 10⁻¹⁰, 10⁻²⁰, 10⁻³⁰ or even less, or more generally may be near the minimum value representable in a machine representation. When a resulting value is below the minimum value representable in a given representation format, such a resulting value cannot then be represented in a machine representation and is approximated by zero. Such an approximation then introduces calculation bias and distorts the final result. In such a context, the proposed computing means implements an aggregation in iterative form by grouping and processing subsets of data. Such iterative aggregation then allows taking into account the machine constraints linked to the data representation, and thus allows improving the precision of the calculations.

Computing means is understood to mean a means of digital calculation, typically a computer, comprising at least one processing unit (e.g., a processor, one or more functional units, etc.) and capable of implementing at least one processing or calculation operation on a plurality of initial data (e.g., initial distributions). In particular, the computing means is capable of representing real values in the form of floats (or floating-point numbers) according to a predefined representation format. In such a predefined representation format, the computing means can then represent floats (considered in absolute value), in machine representation, that are between a minimum representable (real) value and a maximum representable (real) value.

Plurality of initial distributions is understood to mean a form of plurality of observable data, obtained for example from measurements, calculations, readings, estimates, approximations from an input entity. The plurality of initial distributions may for example express a plurality of observables or occurrences of a phenomenon, a parameter, an occurrence, an event, or an item of information. Such initial distributions may then reflect different aspects or correlations of an item of information. For example, such initial distributions may reflect different transmissions of an item of information via different frequency subcarriers, or via different transmission channels in a communication system. An initial distribution may for example refer to a distribution deduced from observing a sample of observable data related to a given parameter or a given item of information. Such an initial distribution may in particular reflect the plausibility, or likelihood, of a value of the given parameter or information, in light of such an observation. For example, given an observed sample received from a communication system, an initial distribution (associated with such an observed sample) may describe the probability of the value of a transmitted symbol. More generally, an initial distribution may refer to any vector of values associated with a given parameter or a given item of information. Each of the plurality of initial distributions may then be represented by or associated with a vector of values. The size of such a vector may then be equivalent to the size of the initial distribution.

A vector of values is understood to mean a vector representing the initial distribution. For example, in the case of an initial distribution associated with the roll of an unbalanced six-sided die, an initial distribution may take the form of the vector of real values [0.1; 0.3; 0.2; 0.05; 0.15; 0.2], in which the values are associated with the probabilities of obtaining each of the six faces of the die.

A grouping of distributions is understood to mean a partitioning of several distributions into subsets, or distribution partitions. In particular, such a grouping may depend on grouping criteria. In particular, the grouping is implemented, at each iteration, such that the operations applied to the distribution subsets involve machine-representable values and avoid arithmetic underflow.

Term-by-term product operations on distribution subsets is understood to mean, for each subset formed, calculating a product over each component of the vectors of values associated with the distributions in the subset. The result of a term-by-term product operation between several distributions is a distribution, referred to as an intermediate distribution, of the same size as the distributions of the product.

Normalization operation can be understood to mean the application of a normalization factor or function to the components of a distribution (i.e., the values of the associated vector) in order to normalize the distribution. For example, normalization may be applied to a distribution so that the sum of the values is equal to a constant, for example 1, 0, or any other real value.

The features set forth in the following paragraphs may optionally be implemented, independently of one another or in combination with one another:

In one embodiment, the computing means is further configured to implement: a comparison to one another of the values of the vectors of the plurality of initial distributions, such that the distribution subsets are formed based on at least said comparison.

Advantageously, the computing means performs pre-processing of the plurality of initial distributions, which allows quantifying the values manipulated by the computing means. By comparing the values of the vectors with one another, the computing means can quantify in particular whether an aggregation-based processing of such values will involve manipulating resulting values that are near the minimum value representable, in a given stage of the aggregation. Therefore, such a comparison allows the computing means to anticipate the potential occurrence of an arithmetic underflow, due to the absolute or relative order of magnitude of the manipulated values, and thus to define grouping criteria adapted to the plurality of initial distributions to be manipulated so as to allow aggregating the plurality with no loss of values.

In one embodiment, the computing means is configured to aggregate the plurality of initial distributions in the form of a reduction tree, said reduction tree comprising nodes corresponding to the product operations followed by the normalization operation, and branches corresponding to the formation of distribution subsets.

As a result, the computing means is advantageously configured to implement an iterative aggregation in the form of a tree structure representing the plurality of initial distributions. In particular, such a tree structure makes it possible to illustrate the number and size of the calculations as well as the number of iterations implemented by the computing means, for example via the width, the degree of depth (or levels), and the number of nodes and branches of the reduction tree. For example, the number of roots of the reduction tree represents the number of subsets formed. In particular, the reduction tree contains a single leaf, representing the only aggregated distribution obtained at the end of the iterative aggregation implemented by the computing means.

Aggregation in the form of a reduction tree can be understood to mean an algorithmic construction implemented by the computing means, which allows prioritizing the succession of calculations and processing applied over the plurality of initial distributions. In particular, the aggregation method of the computing means may take into account structural, architectural, and/or mathematical constraints and parameters related to the implementation of the reduction tree (for example, symmetry in the cascade calculations reflected by symmetry in the reduction tree at different levels, a maximum number of parallel calculations reflected by a maximum width of the reduction tree, etc.).

In one embodiment, the computing means is configured to form distribution subsets having maximum sizes in which the product operations lead to resulting values that are strictly greater than the minimum representable value, such that there is a minimal number of normalization operations to obtain the aggregated distribution.

As a result, the computing means may form distribution subsets according to given grouping criteria, such grouping criteria making it possible to take into account algorithmic constraints and overheads or execution times by the computing means, for example. In particular, a grouping criterion may be to form distribution subsets leading to manipulated values at the limit or near the minimum representable value, so as to minimize the number of nodes in the reduction tree. In particular, such minimization allows minimizing the number of normalization operations implemented, which advantageously reduces the algorithmic overhead of the computing means, while guaranteeing the absence of arithmetic underflow.

In one embodiment, the predefined representation format is an element among at least: the 16-bit half-precision encoding format, the 32-bit single-precision encoding format, the 64-bit double-precision encoding format, and the 128-bit quadruple-precision encoding format.

In one embodiment, the computing means is configured to aggregate a plurality of initial distributions corresponding to vectors of values between 0 and 1. Furthermore, in one embodiment, the sum of the values of each vector of values between 0 and 1 is equal to 1.

As a result, the proposed computing means advantageously makes it possible to manipulate values, potentially leading to resulting values which decrease as the product operations are applied to the values, while making it possible to avoid arithmetic underflow. Such manipulation then allows processing numerous use cases, in the field of telecommunications in particular, which involve the reconstruction of aggregated information estimated by aggregating (by implementing term-by-term product operations) a plurality of observables (for example, coming from several transmission channels or obtained by demultiplexing) in the form of probability distributions.

In one embodiment, the computing means is configured to aggregate a plurality of initial distributions corresponding to probability vectors of values associated with a same observed variable, into an aggregated distribution corresponding to an estimate of a probability vector of values of said variable.

According to another aspect, a decoder is proposed comprising a computing means as described above and configured to aggregate a plurality of transmissions relating to symbols of a CCSK-CP-OFDM frame, into an aggregated distribution of the estimated values relating to each transmitted symbol.

According to another aspect, a device is proposed for decoding an error-correcting code, comprising a computing means as defined above and configured to aggregate a plurality of distributions relating to information bits of a transmitted message, into an aggregated distribution of the estimated values relating to each information bit transmitted.

According to another aspect, a method is provided for aggregating a plurality of initial distributions of values into an aggregated distribution, implemented by a computing means as defined above.

According to another aspect, a computer program is provided comprising instructions for implementing all or part of a method as defined above when this program is executed by a processor. According to another aspect, a non-transitory computer-readable storage medium is provided, on which such a program is stored.

### BRIEF DESCRIPTION OF THE DRAWINGS

Other features, details and advantages will become apparent from reading the detailed description below, and from analyzing the attached drawings, in which:

FIG. 1 shows a system with a computing means for calculating product reduction, according to one embodiment.

FIG. 2 shows steps of a method of product reduction according to one embodiment.

FIG. 3 shows a product reduction tree according to one embodiment.

FIG. 4 shows a product reduction tree according to another embodiment.

FIG. 5 shows a graph representing a maximum tolerated size of a product reduction tree as a function of the size of the initial distributions, according to one embodiment.

FIG. 6 shows a decoding system with a computing means for calculating product reduction, according to one embodiment.

### DETAILED DESCRIPTION OF CERTAIN ILLUSTRATIVE EMBODIMENTS

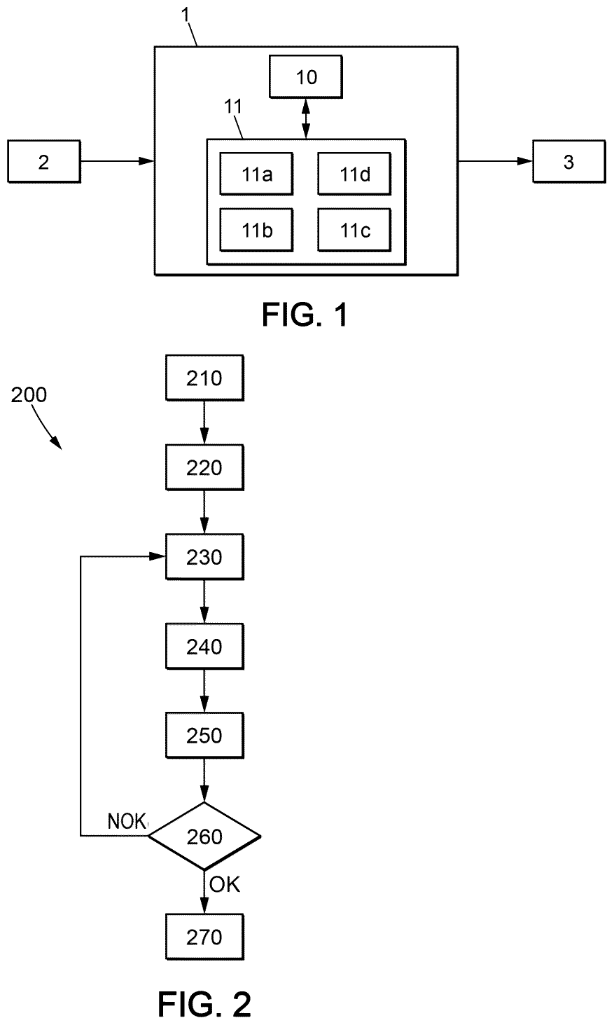

Reference is now made to FIG. 1. FIG. 1 schematically illustrates a processing system comprising a computing means 1, an information input entity 2, and an information output entity 3.

Input entity 2 may correspond to a system or a set of subsystems configured to transmit observable data to computing means 1. Input entity 2 may, for example, correspond to or include a set of information transmission channels, sensors, or a data estimator. The observable data may for example correspond to data measured, captured, entered, estimated, calculated by the subsystem(s) upstream of the computing means. Such observable data may for example correspond to time series, ordered distributions of data recorded or measured according to different parameters, (discrete) probability distributions, or continuous probability density functions. In particular, the observable data may describe the same variable, the same parameter, or, more generally, the same information. For example, the observable data may correspond to a plurality of transmissions describing the same input signal (e.g., multiplexed), a plurality of encoded information bits describing the same message, or a plurality of observations of occurrences of the same event.

In the context of this description, input entity 2 is configured to provide a plurality of distributions, referred to as initial distributions. The initial distributions may take the form of vectors of numerical values (e.g., real numbers) of finite size, typically probability values. The initial distributions may correspond to discrete distributions. In another example, the initial distributions may correspond to estimates of continuous functions, typically probability density functions, estimated at points or values of interest.

Computing means 1 is a processing entity configured to aggregate the plurality of observable data, received in the form of a plurality of initial distributions from input entity 2, into an aggregated distribution. Typically, computing means 1 is configured to estimate an aggregated distribution which allows describing a given piece of information (i.e., a random variable representing the outcome of a given event, an encoded message, a signal, etc.), based on the plurality of observable data all linked to this same piece of information and transmitted by input entity 2. To do this, computing means 1 may include a memory unit 10 and a processor 11. Memory unit 10 may include volatile memory (RAM) and non-volatile memory (ROM). Memory unit 10 may store at least one program comprising instructions for implementing a method of product reduction 200 as will be described below. Processor 11 may include one or more functional units 11a, 11b, 11c, 11d configured to implement the method of product reduction 200 in accordance with the instructions stored in the memory of computing means 1.

In particular, computing means 1 is configured to store, process, and more generally manipulate the observable data, in at least one predefined representation format commonly referred to as machine representation format. The observable data, and more particularly the numerical values contained in the vectors forming the initial distributions, manipulated by computing means 1, may be represented, or encoded, in machine representation by floating-point numbers (or “floats”). The machine representation of such floating-point numbers by computing means 1 depends on the representation format adopted. In particular, such a representation format defines a minimum representable value and a maximum representable value. For example, computing means 1 may encode values in 32-bit single-precision encoding format, 64-bit double-precision encoding format, or 128-bit quadruple-precision encoding format. In other embodiments, any other representation format may be considered by computing means 1. For example, for 32-bit single-precision encoding format, any representable floating number can be encoded by 1 sign bit, 8 exponent bits, and 23 significand bits. Such encoding then allows representing absolute values between approximately 1.17×10⁻³⁸ and 3.4×10⁺³⁸. In other words, when implementing the method of product reduction 200 and more generally when manipulating the initial distributions, computing means 1, by adopting a single-precision representation format, can represent values (positive or negative) having an absolute value of between approximately 1.17×10⁻³⁸ and 3.4×10⁺³⁸.

Reference is now made to FIG. 2. FIG. 2 represents the steps of a method of product reduction 200, implemented by a computing means 1 as represented in FIG. 1, to aggregate a plurality of initial distributions into an aggregated distribution. Typically, the method of product reduction 200 may aim to reconstruct, in an estimated manner, an unknown real distribution from a plurality of observed initial distributions.

In a step 210, a plurality of initial distributions is received by computing means 1. In particular, the plurality of initial distributions may contain several tens, hundreds, or thousands of initial distributions. Such a plurality of initial distributions may in particular take the form of a plurality of vectors of finite sizes, each vector being composed of numerical values. For example, the plurality of initial distributions received in step 210 may be written:
y₁, y₂ . . . , y_{N}
   where:
y₁, y₂, . . . y_{N} are vectors of numerical values associated with the initial distributions N is the number of initial distributions received.

In particular, the plurality of initial distributions received in step 210 is linked to a same piece of input information, modeled by a random variable X whose real distribution is unknown. For example, the random variable X may describe the value of a symbol actually transmitted as input to a transmission system (for example, an information bit that can take the value of 0 or 1). Each of the initial distributions yᵢ can then be linked to a likelihood describing the probability of a value of the random variable X, given observable data linked to the random variable X (for example, given a symbol received during reception, linked to one or more noisy observations during reception).

In a step 220, the plurality of initial distributions received is pre-processed. For example, the pre-processing of step 220 may include determining the number N of initial distributions and their respective sizes Mᵢ. The size Mᵢ of each initial distribution may correspond to the size of the vector yᵢ associated with said initial distribution (i.e., the number of numerical values composing vector yᵢ, where i is a natural integer between 1 and N). In other words, each initial distribution may be represented by yᵢ= [y_{i,1}; y_{i,2}; . . . ; y_{i,M}], where elements y_{i,j} are real numbers (in particular, between 0 and 1), i and j are integers which are respectively between 1 and N and between 1 and M. The size Mᵢ of each initial distribution may depend on the number of possible states for a random variable or a parameter associated with the initial distribution, or on the number of points or values of interest where each initial distribution is estimated. In one embodiment, pre-processing step 220 allows considering initial distributions having the same size M. In the remainder of the description, the initial distributions yᵢ are considered to have the same size, denoted M.

The pre-processing of step 220 may also include estimating, evaluating, or determining the values contained in the vectors y₁, y₂, . . . y_{N} associated with the initial distributions (i.e., values y_{i,j}). The pre-processing of step 220 may also include estimating or determining an order of magnitude or an interval within which such values y_{i,j} belong. The pre-processing of step 220 may also include comparing values y_{i,j} with each other and from one vector yᵢ to another.

The pre-processing of step 220 may also take into account the calculation architecture or configuration parameters of computing means 1, for example symmetric processing constraints on calculation operations or constraints on parity of terms in a basic calculation. Such constraints may then be taken into account in step 220. For example, if the number N of initial distributions is odd and an architectural or functional constraint of computing means 1 requires that an even number of distributions be processed, step 220 may include adding uniform distributions to the plurality of initial distributions until a number N is obtained that is a multiple of 2.

The pre-processing of step 220 may also include any other operation of ordering, labeling, or cleaning the initial distributions.

Steps 230, 240, 250, and 260 describe an iterative aggregation of the plurality of initial distributions, where steps 230, 240, 250, and 260 are repeated until an aggregated distribution is obtained. In one embodiment, such an iterative aggregation may also include iterating step 220 or a portion of step 220. Two successive iterations of steps 230, 240, 250, and 260 are now described to illustrate the method of product reduction 200.

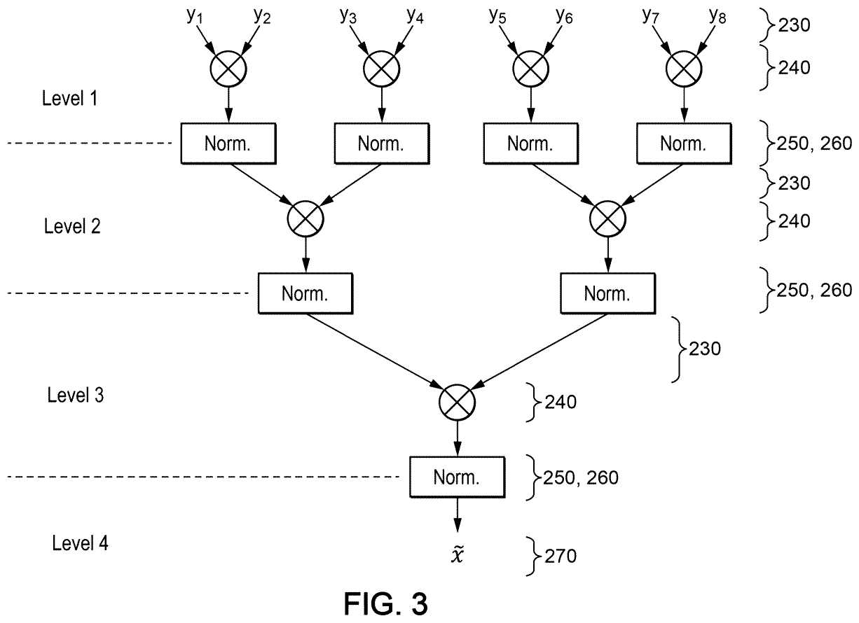

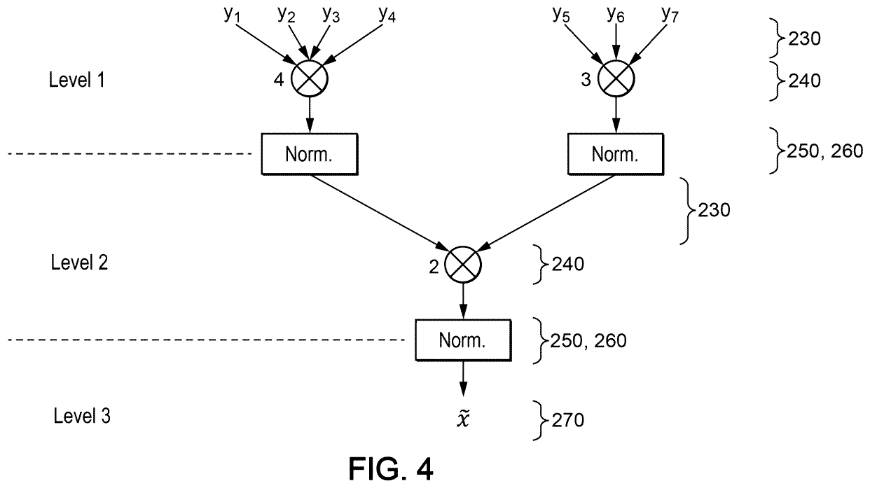

In one embodiment, the iterative aggregation of the plurality of initial distributions into an aggregated distribution may be illustrated in the form of a hierarchical tree, or product reduction tree, as illustrated in FIGS. 3 and 4. One end of the tree (upper end in FIGS. 3 and 4) comprises a plurality of roots representing the plurality of initial distributions and another end of the tree (lower end in FIGS. 3 and 4) comprises a single leaf representing the aggregated distribution.

In a step 230, distribution subsets are formed. To do so, in a first iteration of step 230, the initial distributions are grouped, or partitioned, into finite subsets, such that the number of initial distributions per subset is less than the number N of the plurality of initial distributions. In one embodiment, each distribution subset comprises at least two distributions. In one embodiment, the distributions are grouped into an even number of distribution subsets.

With reference to FIGS. 3 and 4, such a first iteration of step 230 is illustrated by the roots of the trees represented. The roots illustrated in FIG. 3 have eight initial distributions (N=8) grouped into four subsets formed by pairs of vectors {y₁; y₂}, {y₃; y₄}, {y₅; y₆}, and {y₇; y₈}, each distribution subset thus comprising two initial distributions. The roots illustrated in FIG. 4 have seven initial distributions (N=7) grouped into two subsets formed by vectors {y₁; y₂; y₃; y₄} on the one hand and by vectors {y₅; y₆; y₇} on the other hand. In particular, the product reduction tree may be symmetric (i.e., all distribution subsets contain the same number of distributions, as illustrated in FIG. 3) or asymmetric (i.e., the distribution subsets may contain different numbers of distributions, as illustrated in FIG. 4).

One or more grouping criteria may be considered in step 230 to form the distribution subsets. The number of distribution subsets formed and the number of distributions per subset may depend on such grouping criteria. For example, a grouping criterion may be determined from values determined in the pre-processing step 220.

In particular, the distribution subsets are formed such that the term-by-term products calculated on each distribution subset lead to values strictly greater than the minimum value representable in the predefined representation format of computing means 1. For this purpose, in one embodiment of the first iteration, the grouping of the initial distributions in step 230 may depend on the component values of the vectors associated with the initial distributions. In one embodiment of the first iteration, the grouping of the initial distributions in step 230 may depend on comparing, with each other and/or from one vector yᵢ to another, the values composing the vectors yᵢ associated with the initial distributions.

In one embodiment, a grouping criterion may be to maximize an average value associated with the term-by-term product calculated on each subset, so as to avoid the occurrence of a potential arithmetic underflow linked to the product operations implemented over such a subset. In one embodiment, a grouping criterion may be to minimize an average value associated with the term-by-term product calculated on each subset while retaining the values greater than the minimum representable value, so as to optimize the algorithmic complexity of the method 200 while avoiding an arithmetic underflow (when the values of the vectors associated with the distributions are between 0 and 1 for example, this amounts to maximizing a size S of each distribution subset, i.e. the number of distributions on which the term-by-term product operations are implemented). In another embodiment, a grouping criterion may be to form subsets of maximum sizes for which the term-by-term product operations lead to resulting values that are strictly greater than the minimum representable value, on each of the distribution subsets. In other words, a grouping criterion may be to form a minimum number of distribution subsets that satisfy the condition in which the term-by-term products calculated on each distribution subset lead to values that are strictly greater than the minimum representable value. The grouping criteria may be linked to a goal of minimizing the complexity, calculation time, and storage space used (in particular in volatile memory), when implementing the aggregation method 200.

In a step 240, a product reduction is implemented on each distribution subset formed. In other words, in step 240, for each distribution subset, term-by-term product operations are applied across the distributions constituting the distribution subset.

For example, with reference to FIG. 4, the term-by-term products applied to each of the two distribution subsets formed at the end of the first iteration of step 230 respectively lead to these vectors:

$${y}_{1} \times {y}_{2} \times {y}_{3} \times {y}_{4} = [ {\prod }_{i = i}^{4} {y}_{i , 1} ; {\prod }_{i = 1}^{4} {y}_{i , 2} ; … ; {\prod }_{i = 1}^{4} {y}_{i , M} ] ,$$

$$and$$

$${y}_{5} \times {y}_{6} \times {y}_{7} = [ {\prod }_{i = 5}^{7} {y}_{i , 1} ; {\prod }_{i = 5}^{7} {y}_{i , 2} ; … {\prod }_{i = 5}^{7} {y}_{i , M} ]$$

where, for any integer i between 1 and N=7, yᵢ is a vector corresponding to a distribution, for any integer j between 1 and M, y_{i,j} is a real numerical value corresponding to the j-th component of vector yᵢ and Πᵢyᵢ,j is the product of the j-th (real) component of vectors yᵢ, M being the size of each vector yᵢ.

In particular, it is specified that the product yᵢ×y₁ (where i and i′ are integers between 1 and N) corresponds to a vector of the same size as each of the vectors yᵢ and y_{i′}. In the following, the j-th component of such a vector will be denoted yᵢ×y_{i′}[j] in order to simplify the notation.

At the end of step 240, the product reduction implemented term by term results in an intermediate distribution obtained for each distribution subset. Similarly to an initial distribution, such an intermediate distribution may take the form of a vector whose values and size are linked to the initial distributions of the distribution subset from which the intermediate distribution is derived. At the end of step 240, the number of intermediate distributions obtained is equal to the number of distribution subsets formed in the previous step 230.

With reference to FIGS. 3 and 4, four and two intermediate distributions are obtained at the end of step 240 at the first degree of depth (or level 1) of the illustrated product reduction trees.

In a step 250, normalization is implemented on each intermediate distribution. In other words, the normalization operation is implemented for each distribution subset. Such a step 250 is illustrated by the “Norm.” element in FIGS. 3 and 4. In one embodiment, such a normalization step 250 involves applying a normalization factor to the components of the intermediate distributions. In particular, such a normalization factor can allow reducing the sum of such components to 1, and thus raising the values resulting from the product operations, relative to the arithmetic underflow limit (linked to the minimum representable value), particularly in the case of probability distributions (in other words, at the end of such a normalization step 250, the sum of the components of each vector corresponding to an intermediate distribution is equal to 1). In one embodiment, such a normalization step corresponds to an increase in the values obtained at the end of the product operations of step 240, such that the value obtained after normalization is greater than the value obtained at the end of the product operations.

For example, referring to FIG. 3, the results obtained at the first four internal nodes at level 1 in the illustrated tree are respectively:

$$\frac{{y}_{1} \times {y}_{2}}{{\sum }_{j = 1}^{M} {y}_{1} \times {y}_{2} [ j ]} , \frac{{y}_{3} \times {y}_{4}}{{\sum }_{j = 1}^{M} {y}_{3} \times {y}_{4} [ j ]} , \frac{{y}_{5} \times {y}_{6}}{{\sum }_{j = 1}^{M} {y}_{5} \times {y}_{6} [ j ]} and \frac{{y}_{7} \times {y}_{8}}{{\sum }_{j = 1}^{M} {y}_{7} \times {y}_{8} [ j ]} .$$

At the end of step 250, a normalized intermediate distribution is then obtained for each distribution subset.

In a step 260, the number of intermediate distributions obtained is considered.

If only one intermediate distribution is obtained, such an intermediate distribution corresponds to the aggregated distribution and the method 200 terminates in a step 270 of obtaining the aggregated distribution from the plurality of initial distributions.

If at least two intermediate distributions are obtained, the aggregation continues as will be described below, by a new iteration of steps 230, 240, 250 and 260. With reference to FIGS. 3 and 4, at the end of the first iteration (i.e., depth level 1 in the trees represented), four and two intermediate distributions are respectively obtained in the trees. A second degree of depth in the trees of FIGS. 3 and 4 is then considered.

In a second iteration of step 230, the intermediate distributions are grouped. The criteria for grouping such intermediate distributions may correspond to the grouping criteria described for the first iteration. Such grouping criteria may differ from one iteration to another. In particular, for this purpose, part of step 220 may have been iterated in order to quantify the intermediate distributions in the manner implemented in step 220 on the initial distributions in order to implement grouping criteria.

With reference to FIG. 3, at the second degree of depth in the tree (level 2 in FIG. 3), two distribution subsets are formed from the four intermediate distributions. With reference to FIG. 4, at the second degree of depth in the tree (level 2 in FIG. 4), one distribution subset is formed from the two intermediate distributions.

Similarly to the first iteration, step 240 of determining the term-by-term product and step 250 of normalization are implemented on the distribution subsets (this time intermediate ones) thus formed.

Similarly to the first iteration, a step 260 is implemented. With reference to FIG. 3, at the end of the second iteration, at the second depth level in the tree represented (level 2 in FIG. 3), two intermediate distributions are obtained. A third iteration of steps 230, 240, 250 is then implemented on the intermediate distributions obtained at level 3, leading to a fourth depth level in the tree of FIG. 3 (level 4). At this depth level in the tree of FIG. 3, a single intermediate distribution is obtained. The iteration then ends and the final tree of FIG. 3 has four depth levels, level 4 leading to a leaf of the tree.

With reference to FIG. 4, at the end of the second iteration, at the second depth level in the tree represented (level 2 in FIG. 4), a single intermediate distribution is obtained at level 3 in the tree. The iteration then ends and the final tree of FIG. 4 has three depth levels, level 3 leading to a leaf of the tree.

In a step 270, the iterative aggregation ends and a single aggregated distribution ã is obtained. In particular, such an aggregated distribution \tilde{x} makes it possible to describe information while taking into account all of the observable data that were input to computing means 1, by aggregating these observable data. Step 270 may in particular include processing or transmitting such an aggregated distribution \tilde{x} to the information output entity 3, for example in order to use such an aggregated distribution \tilde{x} in other processing or calculations of the processing system.

The product reduction method 200, which alternates term-by-term product operations and normalization operations on distribution subsets, thus makes it possible to obtain a final result that is mathematically identical to methods which aggregate all the initial distributions before normalizing the aggregated result obtained. For example, considering the product reduction tree in FIG. 4, the obtained aggregated distribution \tilde{x} corresponds to:

$$\frac{[ \frac{{y}_{1} \times {y}_{2} \times {y}_{3} \times {y}_{4}}{{\sum }_{j = 1}^{M} {y}_{1} \times {y}_{2} \times {y}_{3} \times {y}_{4} [ j ]} ] \times [ \frac{{y}_{5} \times {y}_{6} \times {y}_{7}}{{\sum }_{j = 1}^{M} {y}_{5} \times {y}_{6} \times {y}_{7} [ j ]} ]}{{\sum }_{k = 1}^{M} ( [ \frac{{y}_{1} \times {y}_{2} \times {y}_{3} \times {y}_{4}}{{\sum }_{j = 1}^{M} {y}_{1} \times {y}_{2} \times {y}_{3} \times {y}_{4} [ j ]} ] \times [ \frac{{y}_{5} \times {y}_{6} \times {y}_{7}}{{\sum }_{j = 1}^{M} {y}_{5} \times {y}_{6} \times {y}_{7} [ j ]} ] ) [ k ]} ↔ \frac{\frac{{y}_{1} \times {y}_{2} \times {y}_{3} \times {y}_{4} \times {y}_{5} \times {y}_{6} \times {y}_{7}}{{\sum }_{j = 1}^{M} {y}_{1} \times {y}_{2} \times {y}_{3} \times {y}_{4} [ j ] \times {\sum }_{j = 1}^{M} {y}_{5} \times {y}_{6} \times {y}_{7} [ j ]}}{\frac{{\sum }_{k = 1}^{M} ( {y}_{1} \times {y}_{2} \times {y}_{3} \times {y}_{4} \times {y}_{5} \times {y}_{6} \times {y}_{7} ) [ k ]}{{\sum }_{j = 1}^{M} {y}_{1} \times {y}_{2} \times {y}_{3} \times {y}_{4} [ j ] \times {\sum }_{j = 1}^{M} {y}_{5} \times {y}_{6} \times {y}_{7} [ j ]}}$$

Such a value is then mathematically equal to the result of a normalized product applied over the set of initial distributions:

$$\frac{{y}_{1} \times {y}_{2} \times {y}_{3} \times {y}_{4} \times {y}_{5} \times {y}_{6} \times {y}_{7}}{{\sum }_{k = 1}^{M} ( {y}_{1} \times {y}_{2} \times {y}_{3} \times {y}_{4} \times {y}_{5} \times {y}_{6} \times {y}_{7} ) [ k ]}$$

However, from a digital point of view, the machine calculation of such a normalized product (for example, the term-by-term product y₁×y₂×y₃×y₄×y₅×y₆×y₇) can lead directly to arithmetic underflow phenomena, particularly when aggregating a plurality of initial distributions, potentially several tens, hundreds, or even thousands of initial distributions, each initial distribution itself possibly including several tens, hundreds, or thousands of states (in other words, N and M can be on the order of several tens, hundreds, or thousands). The aggregation of such quantities of observable data then implies determining a large number of products. In particular, when the initial distributions include very small values (typically between 0 and 1, as is the case for probability distributions), the term-by-term product operations result in manipulating decreasing values that can potentially fall to below the minimum machine-representable value.

Therefore, the proposed method 200 is implemented such that the values manipulated throughout the iterative aggregation are not below the minimum representable value. In one embodiment, such values of the vectors yᵢ associated with the initial distributions are between 0 and 1. In one embodiment, product operations implemented on such values lead to results near the minimum value that is representable in the representation format of computing means 1. In order to take into account such a machine representation constraint on the values, the criteria for grouping the distributions (initial or intermediate) into distribution subsets in step 230 take into account parameters linked to the distributions (in particular initial distributions), such as the number N of initial distributions, the size (or sizes) M of the vectors yᵢ associated with such distributions (initial and intermediate), the absolute order of magnitude of the values of such vectors, and/or the differences between such values from one initial distribution to another. The partitioning of the initial and intermediate distributions into subsets, and therefore the sizing parameters of the product reduction tree (number of nodes, number of degrees of depth in the tree) which allow avoiding the phenomenon of arithmetic underflow vary according to the distribution parameters and the representation format adopted.

For example, considering N uniform distributions of the same size M and a representation format associated with a minimum representable value xₘᵢₙ, arithmetic underflow takes place for the following values:

$$M > \sqrt[N]{\frac{1}{{x}_{min}}} and N > - \frac{log ( {x}_{min} )}{log ( M )} .$$

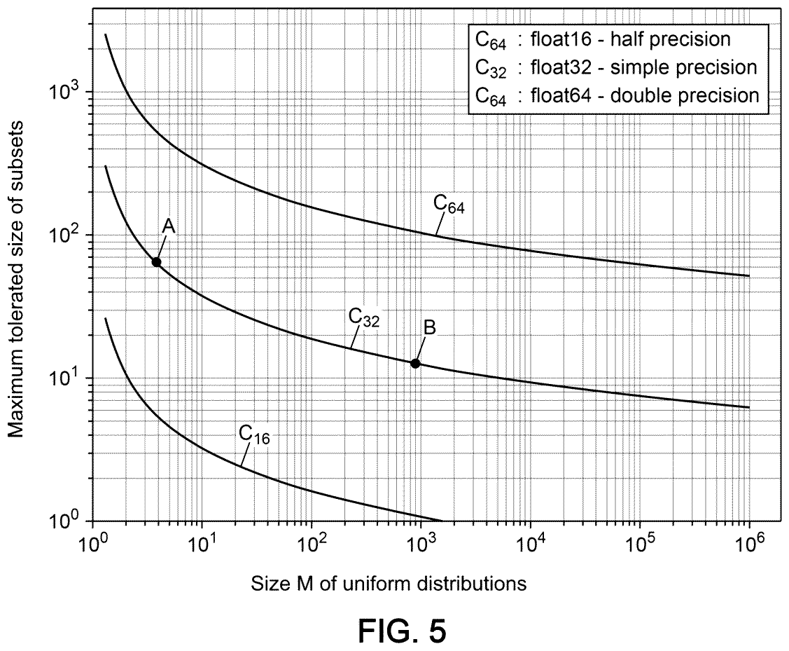

With reference to FIG. 5, a criterion for grouping distributions into subsets is illustrated, taking into account the size M of the distributions, considered to be uniform and of the same size M, and the representation format of computing means 1. The graph illustrated in FIG. 5 represents the maximum tolerated size of a distribution subset (i.e., the maximum size of a distribution subset which allows avoiding an arithmetic underflow) as a function of the size M of the distributions. FIG. 5 illustrates such a maximum size for different representation formats, here 16-bit half-precision encoding, 32-bit single-precision encoding, and 64-bit double-precision encoding, respectively associated with curves C₁₆, C₃₂ and C₆₄.

With reference to FIG. 5, one can see at point A, for example, that for the 32-bit representation format and for a relatively small distribution size M, for example M=4, distribution subsets involving fewer than 60 distributions allow manipulating values greater than the minimum representable value (and therefore allow aggregation by products without generating an arithmetic underflow phenomenon). In an embodiment in which the representation format of computing means 1 is the single-precision format and the size of the vectors yᵢ associated with the initial distributions is on the order of M=4, a grouping criterion may then be to form distribution subsets of approximately 60 distributions in each iteration of the aggregation, so as to maximize the number of distributions per subset while avoiding the arithmetic underflow phenomenon. Such maximization of the number of distributions per subset then makes it possible to minimize the degree of depth in the product reduction tree, the number of normalization operations to be implemented, and therefore the complexity of the method 200.

In another example, with reference to FIG. 5, one can see at point B that for this same 32-bit representation format but for a larger distribution size M, for example M=1000, distribution subsets involving less than approximately 12 distributions allow manipulating values greater than the minimum representable value (and therefore allow aggregation by products without generating an arithmetic underflow phenomenon).

Thus, the sizing of the product reduction tree, in other words the grouping of the distributions into subsets, is to be adapted according to the representation format of computing means 1 and according to the distribution parameters, so as to allow optimizing the execution of the method 200. Depending on these parameters, it is possible to adapt the size of each of the distribution subsets formed and the number of nodes (i.e., the number of calculation nodes at which term-by-term product operations and normalization operations are implemented) at each depth level in the tree, so as to control the complexity or the algorithmic overhead of implementing the method 200. For example, by considering subsets of two distributions in a symmetric tree, typically a balanced binary tree (or, for subsets of a same size S, for balanced S-ary trees), the number of nodes in the product reduction tree increases linearly with the number N of distributions to be aggregated, when N tends towards infinity: the number of calculations to be implemented for the iterative aggregation of distributions does not explode when the number of distributions to be aggregated increases. Such a number of nodes tends in particular towards

$$\frac{N}{S - 1} ,$$

when the IN initial distributions are iteratively grouped by subsets of a same size S, within a balanced and complete S-ary tree.

### EXAMPLES

### First Exemplary Embodiment

In a first exemplary embodiment, communication systems are considered which are based on a relative representation of information to be transmitted or processed (a signal, for example). For example, in the context of a communication system (for example, using CCSK, QPSK, QAM modulation, etc.), information in the form of a succession of symbols can be integrated into a frame (e.g., an OFDM frame, and more particularly a CCSK-CP-OFDM frame), on frequency subcarriers. For example, a CCSK-CP-OFDM frame can take the form of a time-frequency frame, each time step containing a complete CCSK symbol on all of the frequency subcarriers. Such a frame can be schematically represented by a matrix of size (M,N) as follows:

$$[ \begin{matrix}{c}_{1} ( M ) & ⋯ & {c}_{N} ( M ) \\ ⋮ & ⋱ & ⋮ \\ {c}_{1} ( 1 ) & ⋯ & {c}_{N} ( 1 )\end{matrix} ]$$

where cₐ(b) is a component of a CCSK symbol in the a-th time step (a being an integer between 1 and N) and on the b-th frequency subcarrier (b being an integer between 1 and M).

Such a CCSK-CP-OFDM frame may be for example represented differentially at reception, in the form of a matrix of probabilities of relative offsets between symbols of the frame. Such a matrix may for example be written:

$$[ \begin{matrix}{P}_{1 / 1} & ⋯ & {P}_{N / 1} \\ ⋮ & ⋱ & ⋮ \\ {P}_{1 / N} & ⋯ & {P}_{N / N}\end{matrix} ]$$

where P_{i/j} is a vector of size M (i.e., the size of a complete CCSK symbol) resembling a probability distribution of the relative offset between symbols i and j of the CCSK-CP-OFDM frame.

In particular, each component P_{i/j}[k] of vector P_{i/j} (where k is an integer between 1 and M) represents the probability that the value of the difference between symbols i and j of the CCSK-CP-OFDM frame corresponds to the value k.

Such a probability matrix of relative offsets between symbols of the frame may then be used to deduce relative distributions (i.e., relative offset) for any pair of symbols of the frame. For example, from distributions P_{3/1} and P_{5/3} (i.e., respectively the distributions of relative deviations between symbols 1 and 3, and between symbols 3 and 5, of the frame), it is possible to deduce a distribution of relative deviations between symbols 5 and 1, via a transitive relation with respect to symbol 3. For example, such a deviation may be deduced using a convolution or cross-correlation operation.

To generalize, for all symbols i and j of the CCSK-CP-OFDM frame, a relative distribution of symbol i with respect to symbol j may be deduced by combining relative distributions coming from the probability matrix of relative offsets between symbols of the frame:

$${P}_{i / j}^{( a )} = {P}_{i / a} * {P}_{a / j}$$

where P_{i/j}^{(a)} is a distribution of relative deviations between symbols i and j via a transitive relation with respect to symbol a, P_{i/a} and P_{a/j} are relative distributions coming from the probability matrix of relative offsets between the respective symbols i and a, and a and j, of the frame, and where i, j, and a are symbols of the frame.

The probability matrix of relative offsets between the symbols of the frame then provides diverse estimates of the relative deviations between two symbols of a frame. For example, a first estimate is provided by distribution P_{i/j} which itself comes from the matrix. Other estimates are provided by the plurality of distributions that can be deduced via transitivity with respect to all the other symbols of the frame.

An aggregation of such a plurality of distributions may then allow obtaining an aggregated distribution reflecting an estimate of the distribution of relative deviations between two symbols of a CCSK-CP-OFDM frame. In other words, such an aggregated distribution may be determined by:

$${\tilde{P}}_{i / j} = {P}_{i / j} \times {\prod }_{a} {P}_{i / j}^{( a )}$$

where \tilde{P}_{i/j} is an estimated aggregated distribution of the relative deviations between symbols i and j of the frame; P_{i/j} is the distribution of the relative deviations between symbols i and j of the frame that comes from the probability matrix of relative offsets between symbols of the frame; Π_{α}P_{i/j}^{(α)} is the product of the distributions that can be deduced by transitivity with respect to all other symbols of the frame.

Such an aggregate distribution \tilde{P}_{i/j} which allows estimating a relative distribution of a symbol i of a frame with respect to a symbol j may then be implemented by a computing means 1 integrated into a decoder for the CCSK-CP-OFDM frame, based on a plurality of initial distributions P_{i/j}^{(α)} obtained for each symbol a of the frame.

### Second Exemplary Embodiment

In a second exemplary embodiment, an error-correcting code or a repetition mechanism is considered in which portions of information are encoded with redundancy in order to allow for possible errors or losses during transmission.

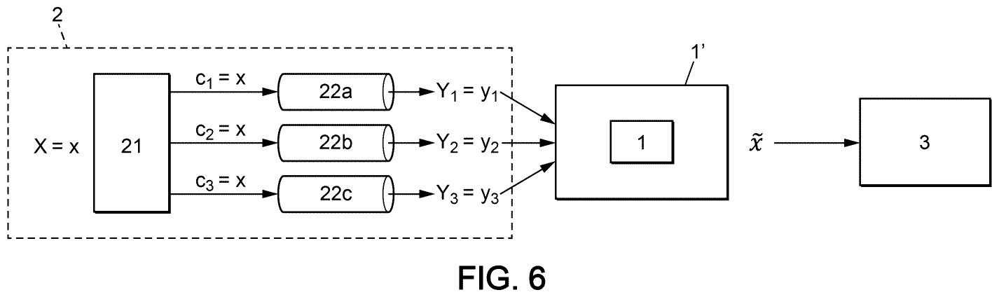

For example, with reference to FIG. 6, an input entity 2 may include an encoder 21, configured to encode each bit x of information (e.g., a message) X (modeled here by a random variable). Such an encoder 21 may then integrate a repetition mechanism, for example a repetition code. In the example of FIG. 6, each bit is repeated three times via three transmission channels 22a, 22b, 22c (in other words, each bit x of information is transmitted three times).

Such information redundancy results in a plurality (here three, in the example of FIG. 6) of transmissions Y₁, Y₂, Y₃ containing redundant information. Such redundant information may then be aggregated during decoding by a decoding device 1′ which integrates a computing means 1 configured to aggregate the plurality of redundant transmissions into aggregated information \tilde{x}. Such aggregated information can be denoted \tilde{x}.

More precisely, in the context of FIG. 6, the estimation of the transmitted information bit may for example be determined by an approach using maximum likelihood, via the following expression:

$$\tilde{x} = A r g {max}_{x} {P}_{X \vert {Y}_{1} , {Y}_{2} , {Y}_{3}} ( x \vert {y}_{1} , {y}_{2} , {y}_{3} )$$

Such an expression may be generalized to a random variable X having a plurality of states and for a plurality of transmissions yᵢ (e.g. N transmissions, N=3 in FIG. 6).

In the context of FIG. 6, such an expression may be written as follows, X being a binary random variable (information bit of 0 or 1):

$$\tilde{x} = Argmax ( \begin{matrix}{P}_{X \vert {Y}_{1}} ( x = 0 \vert {y}_{1} ) \times {P}_{X \vert {Y}_{2}} ( x = 0 \vert {y}_{2} ) \times {P}_{X \vert {Y}_{3}} ( x = 0 \vert {y}_{3} ) \\ {P}_{X \vert {Y}_{1}} ( x = 1 \vert {y}_{1} ) \times {P}_{X \vert {Y}_{2}} ( x = 1 \vert {y}_{2} ) \times {P}_{X \vert {Y}_{3}} ( x = 1 \vert {y}_{3} )\end{matrix} )$$

More generally, the estimation of a distribution of the random variable X from a plurality of observations Yᵢ may be expressed by the maximum likelihood in the following expression (illustrated with i being between 1 and N=3, in the context of FIG. 6):

$${P}_{X \vert {Y}_{1} , {Y}_{2} , {Y}_{3}} ( x \vert {y}_{1} , {y}_{2} , {y}_{3} ) = \frac{{P}_{{Y}_{1} , {Y}_{2} , {Y}_{3} \vert X} ( {y}_{1} , {y}_{2} , {y}_{3} \vert x ) \times {P}_{X} ( x )}{{P}_{{Y}_{1} , {Y}_{2} , {Y}_{3}} ( {y}_{1} , {y}_{2} , {y}_{3} )}$$

By considering a fixed state X (typically, a given information bit X=x), transmissions Y₁, Y₂, Y₃ can be considered independent if transmission channels 22a, 22b, 22c are independent. In this case:

$${P}_{X \vert {Y}_{1} , {Y}_{2} , {Y}_{3}} ( x \vert {y}_{1} , {y}_{2} , {y}_{3} ) = \frac{{P}_{{Y}_{1} \vert X} ( {y}_{1} \vert x ) \times {P}_{{Y}_{2} \vert X} ( {y}_{2} \vert x ) \times {P}_{{Y}_{3} \vert X} ( {y}_{3} \vert x ) \times {P}_{X} ( x )}{{P}_{{Y}_{1} , {Y}_{2} , {Y}_{3}} ( {y}_{1} , {y}_{2} , {y}_{3} )} = \frac{{P}_{X \vert {Y}_{1}} ( x \vert {y}_{1} ) \times {P}_{{Y}_{1}} ( {y}_{1} )}{{P}_{X} ( x )} \times \frac{{P}_{X \vert {Y}_{2}} ( x \vert {y}_{2} ) \times {P}_{{Y}_{2}} ( {y}_{2} )}{{P}_{X} ( x )} \times \frac{{P}_{X \vert {Y}_{3}} ( x \vert {y}_{3} ) \times {P}_{{Y}_{3}} ( {y}_{3} )}{{P}_{X} ( x )} = \frac{{P}_{X} ( x )}{{P}_{{Y}_{1} , {Y}_{2} , {Y}_{3}} ( {y}_{1} , {y}_{2} , {y}_{3} )} \times {\prod }_{j = 1}^{3} \frac{{P}_{X \vert {Y}_{j}} ( x \vert {y}_{j} ) \times {P}_{{Y}_{j}} ( {y}_{j} )}{{P}_{X} ( x )}$$

In the context of a plurality of initial distributions (or transmissions) obtained and a random variable X following a uniform distribution, the elements Pₓ(x), P_{Y}_{₁}_{,Y}_{₂}_{,Y}_{₃} (y₁, y₂, y₃) and P_{Y}_{ⱼ}(yⱼ) are constant and can be represented by a constant factor C. Estimating a distribution X from the plurality of distributions Yᵢ may then be simplified by:

$${P}_{X \vert {Y}_{1} , {Y}_{2} , {Y}_{3}} ( x \vert {y}_{1} , {y}_{2} , {y}_{3} ) = C \times {\prod }_{j = 1}^{3} {P}_{X \vert {Y}_{j}} ( x \vert {y}_{j} )$$

Thus, in the context of a plurality of redundant pieces of information or a plurality of estimates linked to a same parameter or a same piece of information X (e.g., an information bit x or a distribution of relative deviations between two symbols of a frame), the aggregation of such a plurality of information or of estimates in the form of distributions can be likened to calculating a product of distributions. A computing means 1 as described in FIG. 1 and configured to implement an aggregation method 200 as described in FIG. 2 may then be used.

In particular, in the application examples described, such a computing means may be involved during a phase of decoding an encoded message or an OFDM frame, for example by being integrated into a decoder or a decoding device 1′, so as to restore estimated information in an aggregated form.

### LIST OF REFERENCE NUMBERS

1: computing means
1′: decoding device
10: memory unit
11: processor
11a, 11b, 11c, 11d: functional units
2: input entity
21: encoder
22a, 22b, 22c: transmission channels
3: output entity

What is claimed is:

1. A computing means configured to aggregate a plurality of initial distributions into an aggregated distribution, the initial distributions being associated with vectors of values, each value being a real floating-point number and being representable by the computing means in a predefined representation format in which the values representable in this format are between a minimum representable value and a maximum representable value,
wherein, for the aggregation of the initial distributions, the computing means is configured to implement, iteratively:
a grouping of distributions to form a plurality of distribution subsets, and
product operations, term-by-term, on the distribution subsets, the products resulting in at least one intermediate distribution, followed by a normalization operation on each intermediate distribution,
until the aggregated distribution is obtained,
wherein each grouping of distributions is implemented such that the product operations on the distribution subsets lead to resulting values that are strictly greater than the minimum representable value.

2. The computing means according to claim 1, further configured to implement:
a comparison to one another of the values of the vectors of the plurality of initial distributions,
such that the distribution subsets are formed based on at least of the comparison.

3. The computing means according to claim 1, configured to aggregate the plurality of initial distributions in the form of a reduction tree, the reduction tree comprising nodes corresponding to the product operations followed by the normalization operation, and branches corresponding to the formation of distribution subsets.

4. The computing means according to claim 1, configured to form distribution subsets having maximum sizes in which the product operations lead to resulting values that are strictly greater than the minimum representable value, such that there is a minimal number of normalization operations to obtain the aggregated distribution.

5. The computing means according to claim 1, wherein the predefined representation format is an element among at least: the 16-bit half-precision encoding format, the 32-bit single-precision encoding format, the 64-bit double-precision encoding format, and the 128-bit quadruple-precision encoding format.

6. The computing means according to claim 1, configured to aggregate a plurality of initial distributions corresponding to vectors of values between 0 and 1.

7. The computing means according to claim 1, configured to aggregate a plurality of initial distributions corresponding to probability vectors of values associated with a same observed variable, into an aggregated distribution corresponding to an estimate of a probability vector of values of the variable.

8. A decoder comprising a computing means according to claim 1, configured to aggregate a plurality of transmissions relating to symbols of a CCSK-CP-OFDM frame, into an aggregated distribution of the estimated values relating to each transmitted symbol.

9. A device for decoding an error-correcting code, comprising the computing means according to claim 1 for aggregating a plurality of distributions relating to information bits of a transmitted message, into an aggregated distribution of the estimated values relating to each information bit transmitted.

10. A method of aggregating a plurality of initial distributions of values into an aggregated distribution, implemented by the computing means defined according to claim 1.

11. A processing circuit comprising a processor and a memory, the memory storing program code instructions of a computer program to implement the method according to claim 10 when the computer program is executed by the processor.

12. A non-transitory computer-readable storage medium on which is stored a computer program to implement the method according to claim 10 when the computer program is executed by a processor.
